(19) United States
(12) Patent Application Publication
(10) Pub. No.: US 2010/0269585 A1
(43) Pub. Date: Oct. 28, 2010

(54) LIQUID DETECTING DEVICE

(76) Inventor: Ching-Dien Chen, Taichung Hsien (TW)

Correspondence Address: Chien-Hui Su, P. O. Box 70-121 Taichung, Taichung City, 40899, TW

(21) Appl. No.: 12/428,447

(22) Filed: Apr. 22, 2009

(51) Int. Cl. G01F 23/30

(52) U.S. Cl. 73/306

(57) ABSTRACT

A liquid detecting device includes a water tank, a stabilizer received in the water tank, a floating element received in the water tank, and a sensor disposed underneath the water tank. The floating element has a first end and a second end. A volume of the first end is greater than that of the second end. The floating element has a permanent magnet disposed in the second end. When the water tank is filled with water, the first end is floating such that the stabilizer abuts against the floating element. The second end rotates to approach the sensor such that the sensor interacts with the permanent magnet to indicate presence of water. When the water tank is empty, the first end abuts against the water tank such that second end is away from the sensor. The sensor does not interact with the permanent magnet to indicate absence of water.

### BACKGROUND OF THE INVENTION

1. Field of the Invention

The present invention relates to a liquid detecting device, and more particularly to a liquid detecting device for detecting the presence or absence of the liquid.

2. Description of Related Art

A conventional liquid detecting device in accordance with the prior art comprises a tank for receiving and retaining a liquid and a filling port. A dispenser supplies liquid to the tank through a nozzle which engages the filling port. A pneumatic detection system is provided for fluidly measuring the liquid level state within the tank; i.e., determining whether or not the tank is full. An optical detection system is also provided, which cooperates with the pneumatic detection system, for optically measuring the liquid level state within the tank. The conventional optical/pneumatic liquid detecting device is easily affected by temperature and humidity. Especially, when the liquid or the gas permeates into the conventional liquid detecting device, the conventional liquid detecting device is out of function.

The present invention has arisen to mitigate and/or obviate the disadvantages of the conventional liquid detecting device.

### SUMMARY OF THE INVENTION

The main objective of the present invention is to provide an improved liquid detecting device for detecting the presence or absence of the liquid.

To achieve the objective, the liquid detecting device includes a water tank, a stabilizer received in the water tank, a floating element received in the water tank, and a sensor disposed underneath the water tank. The stabilizer has a rod extended therefrom. The floating element is operatively connected to the stabilizer. The floating element has a first end and a second end opposite to the first end. A volume of the first end is greater than that of the second end. The floating element has a recess defined therein and disposed between the first end and the second end. The floating element has a first bottom face defined in the first end and a second bottom face defined in the second end. The second bottom face has a predetermined angle with respect to the first bottom face. The floating element has a permanent magnet disposed in the second end. The rod protrudes in the recess. The sensor is corresponding to the floating element. When the water tank is filled with water, the first end is floating such that the rod abuts against a bottom of the recess. The second end rotates to approach the sensor such that the sensor interacts with the permanent magnet to indicate presence of water. When the water tank is empty, the first bottom face abuts against a bottom of the water tank such that second end is away from the sensor. The sensor does not interact with the permanent magnet to indicate absence of water.

Further benefits and advantages of the present invention will become apparent after a careful reading of the detailed description with appropriate reference to the accompanying drawings.

### BRIEF DESCRIPTION OF THE DRAWINGS

FIG. 1 is an exploded perspective view of a liquid detecting device in accordance with the present invention;

FIG. 2 is a perspective view of the stabilizer of the liquid detecting device in accordance with the present invention;

FIG. 3 is an enlarged cross sectional view of the rod of the stabilizer taken along line 3-3 in FIG. 2;

FIG. 4 is a perspective view of the floating element of the liquid detecting device in accordance with the present invention;

FIG. 5 is a cross sectional view of the floating element taken along line 5-5 in FIG. 4;

FIG. 6 is a partial top plane view of the liquid detecting device in accordance with the present invention;

FIG. 7 is an assembled perspective view of the liquid detecting device in accordance with the present invention;

FIG. 8 shows the installation of the liquid detecting device in a coffee brewing machine;

FIG. 9 shows the operation of the liquid detecting device when the water tank is filled with water; and

FIG. 10 shows the operation of the liquid detecting device when the water tank is empty.

### DETAILED DESCRIPTION OF THE INVENTION

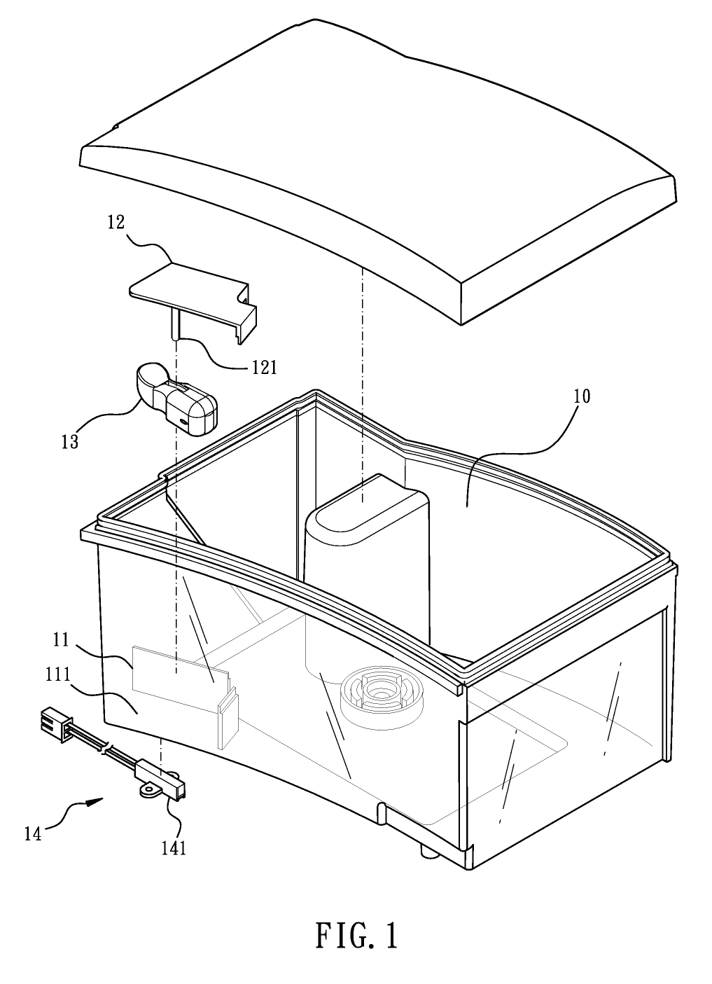

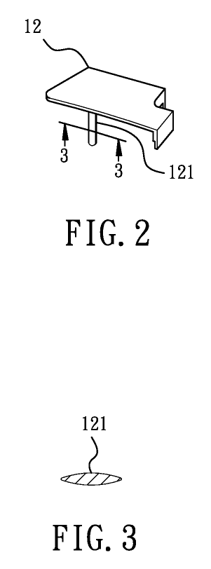

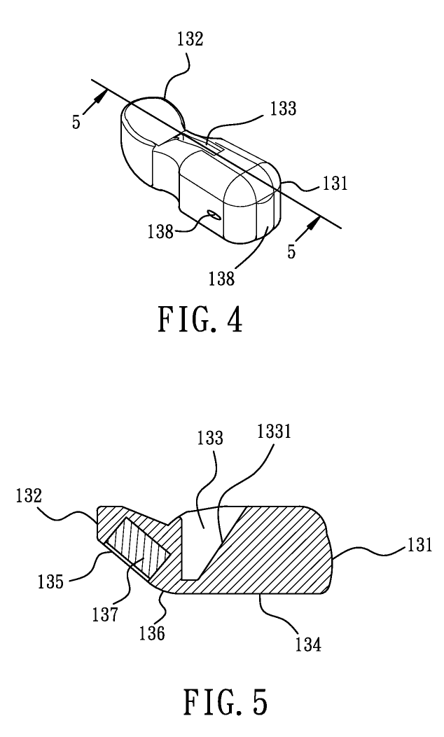

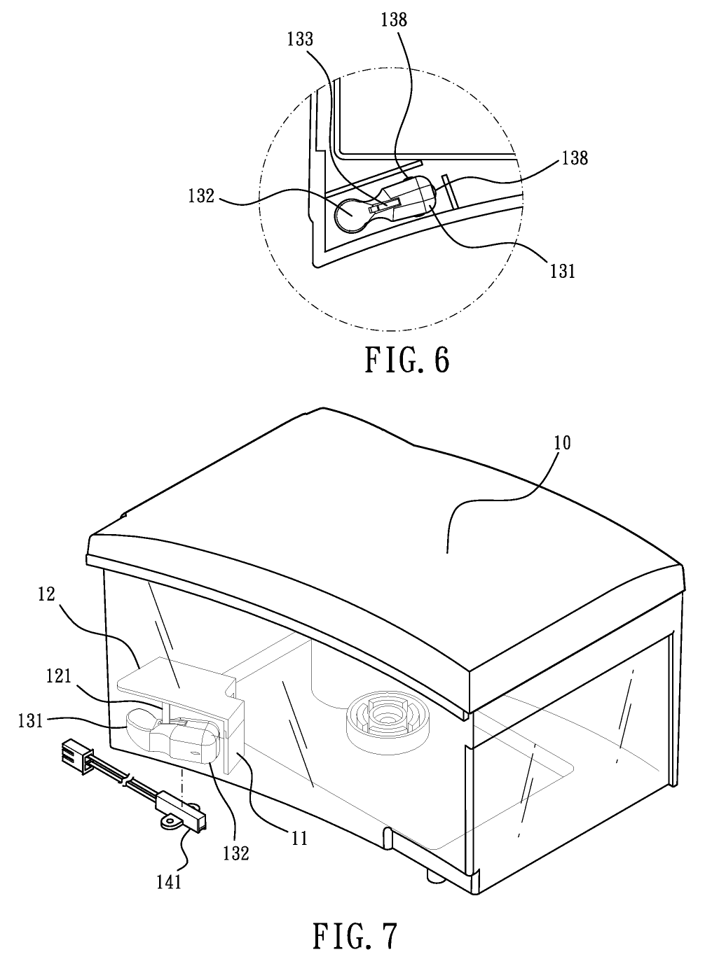

Referring to the drawings and initially to FIGS. 1-7, a liquid detecting device in accordance with the present invention comprises a water tank 10, a partition 11 disposed in the tank 10, a stabilizer 12 connected to the tank 10, a floating element 13 operatively connected to the stabilizer 12, and a sensor 14 disposed underneath the tank 10.

The partition 11 is disposed in a corner of the water tank 10. An installing space 111 is defined in a space enclosed by the partition 11 and the corner of the water tank 10. The installing space 111 is provided to receive the floating element 13. The installing space 111 is communicated with the water tank 10.

The stabilizer 12 is disposed in a top of the partition 11. The stabilizer 12 has a rod 121 extended therefrom and into the installing space 111. The rod 121 has a section of airfoil contour to reduce the contacting area and the friction.

The floating element 13 is made of plastic. The floating element 13 is received in the installing space 111 and is abutted against the rod 121 of the stabilizer 12. The floating element 13 has a first end 131 and a second end 132 opposite to the first end 131. A volume of the first end 131 is greater than that of the second end 132 such that a weight of the first end 131 is greater than that of the second end 132. When the floating element is immersed in the water, a buoyancy of the first end 131 is greater than that of the second end 132. The floating element 13 has a recess 133 defined therein and between the first end 131 and the second end 132. The rod 121 of the stabilized 12 is protruded into the recess 133 and abutted against a bottom of the recess 133. The floating element 13 has an inclined face 1331 formed in the recess 133 and inclined toward the first end 131 such that an open end of the recess 133 is larger than the bottom of the recess 133. The floating element 13 has a first bottom face 134 defined in the first end 131 and a second bottom face 135 defined in the second end 132. The second bottom face 135 has a predetermined angle with respective to the first bottom face 134. A round surface 136 is defined between the first bottom face 134 and the second bottom face 135. The round surface 136 is provided for a smooth movement of the floating element 13. The floating element 13 has a permanent magnet 137 disposed in the second end 132.

The floating element 13 has multiple ribs 138 formed in an outer peripheral thereof. The multiple ribs 138 is provided for keeping a gap between the floating element 13 and the partition 11 or the water tank 10 such that the friction between the floating element 13 and the partition 11 or the water tank 10 is reduced to stabilize movement of the floating element 13.

The sensor 14 is a magnetism reed switch 141. The magnetism reed switch 141 is disposed underneath the water tank 10 and corresponding to the floating element 13. When the permanent magnet 137 approaches the magnetism reed switch 141, the sensor 14 sends a signal to indicate the presence of the water. When the permanent magnet 137 is away from the magnetism reed switch 141, the sensor 14 sends a warning signal to indicate the absence of the water.

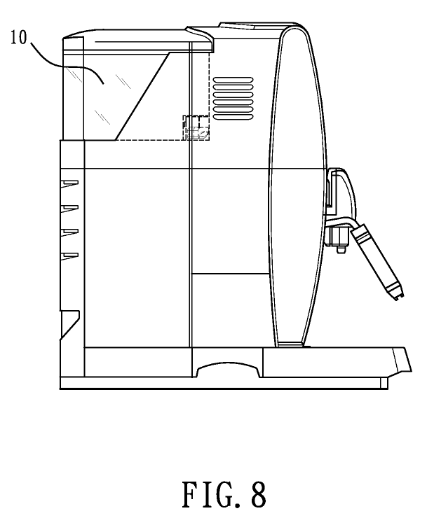

Referring to FIG. 8, the installation of the liquid detecting device in a coffee brewing machine is illustrated.

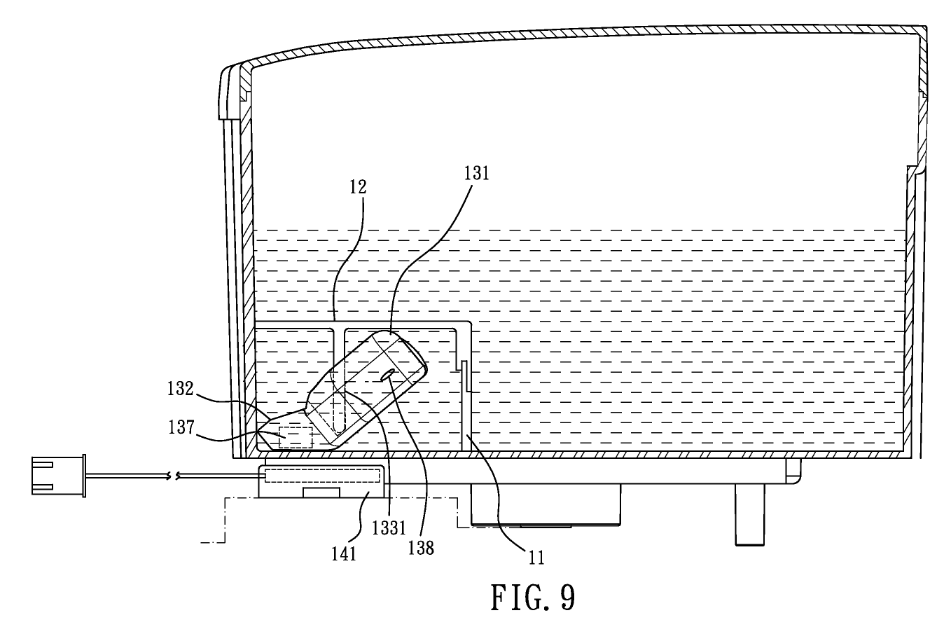

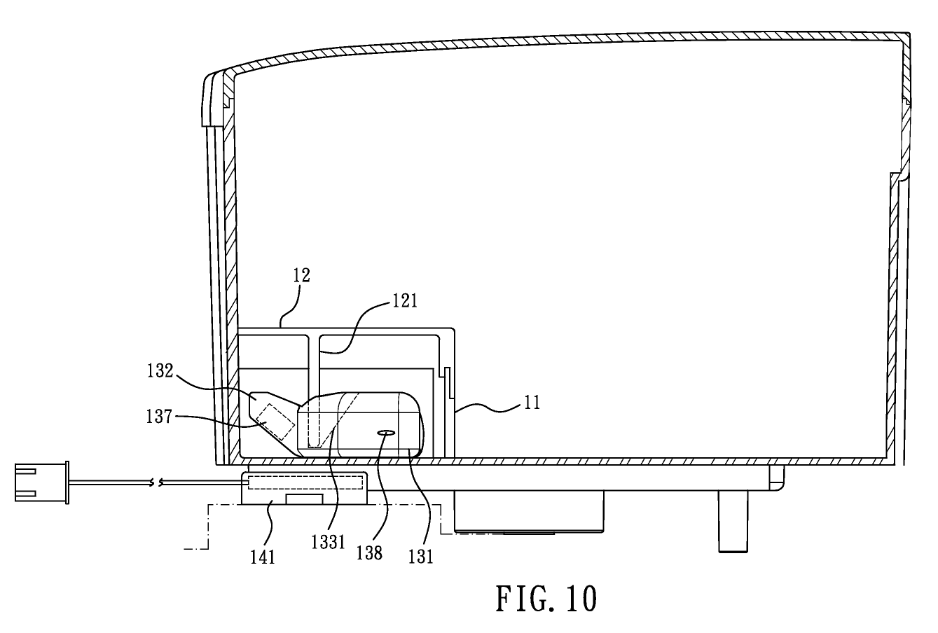

Referring to FIGS. 9 and 10, the operation of the liquid detecting device in accordance with the present invention is illustrated. When the water tank 10 is filled with water as shown in FIG. 9, the floating element 13 is subjected the buoyancy such that the first end 131 is floating. In the meantime, the rod 121 is abutted against the bottom of the recess 133 and the inclined face 1331 such that the second end 131 rotates toward the bottom of the water tank 10 to approach the magnetism reed switch 141. Therefore, the sensor 14 sends the signal to indicate the presence of the water. When the water tank 10 is empty as shown in FIG. 10, the first bottom face 134 of the first end 131 abuts against the bottom of the water tank 10. In the meantime, the second end 132 is away from the bottom of the water tank 10. Therefore, the sensor 14 sends the warning signal to indicate the absence of the water.

Although the invention has been explained in relation to its preferred embodiment, it is to be understood that many other possible modifications and variations can be made without departing from the spirit and scope of the invention as hereinafter claimed.

What is claimed is:

1. A liquid detecting device comprising:
a stabilizer adapted to be received in a water tank, the stabilizer having a rod extended therefrom;
a floating element adapted to be received in the water tank, the floating element operatively connected to the stabilizer, the floating element having a first end and a second end opposite to the first end, a volume of the first end being greater than that of the second end, the floating element having a recess defined therein and disposed between the first end and the second end, the floating element having a first bottom face defined in the first end and a second bottom face defined in the second end, the second bottom face having a predetermined angle with respect to the first bottom face, the floating element having a permanent magnet disposed in the second end; where in the rod protrudes in the recess; and
a sensor adapted to be disposed underneath the water tank, the sensor corresponding to the floating element;
wherein when the water tank is filled with water, the first end is floating such that the rod abuts against a bottom of the recess; the second end rotates to approach the sensor such that the sensor interacts with the permanent magnet to indicate presence of water;
wherein when the water tank is empty, the first bottom face abuts against a bottom of the water tank such that second end is away from the sensor; the sensor does not interact with the permanent magnet to indicate absence of water.

2. The liquid detecting device as claimed in claim 1 further comprising a partition adapted to be received in the water tank, an installing space defined between the partition and the water tank for receiving the floating element.

3. The liquid detecting device as claimed in claim 2, wherein the stabilizer is disposed in a top of the partition.

4. The liquid detecting device as claimed in claim 1, wherein the floating element has multiple ribs formed in an outer peripheral thereof.

5. The liquid detecting device as claimed in claim 1, wherein the floating element has an inclined face formed in the recess and inclined toward the first end.

6. The liquid detecting device as claimed in claim 1, wherein the rod has a section of airfoil contour.

7. The liquid detecting device as claimed in claim 1, wherein a weight of the first end is greater than that of the second end.

8. The liquid detecting device as claimed in claim 1, wherein a buoyancy of the first end is greater than that of the second end.
